(19) United States
(12) Patent Application Publication
(10) Pub. No.: US 2010/0098840 A1
(43) Pub. Date: Apr. 22, 2010

(54) METHOD OF MANUFACTURING BACK ELECTRODE OF SILICON BULK SOLAR CELL

(75) Inventors: Chen-Hsun Du, Taipei City (TW); Shih-Peng Hsu, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/340,755

(22) Filed: Dec. 22, 2008

(30) Foreign Application Priority Data
Oct. 22, 2008 (TW) 97140504

(51) Int. Cl. B05D 5/12

(52) U.S. Cl. 427/75; 427/74

(57) ABSTRACT

A method of manufacturing a back electrode of a silicon bulk solar cell is provided, which includes depositing a passivation layer on a back of a silicon substrate, and then coating a first metal paste on the passivation layer. Thereafter, a first sintering is performed at a high temperature, such that the first metal paste penetrates the passivation layer, joints to the silicon substrate, and diffuses into the back of the silicon substrate. Afterward, a second metal paste is coated on the back of the silicon substrate, and then a second sintering is performed at a low temperature to cure the second metal paste without penetrating the passivation layer, so as to finish the back electrode structure. Therefore, this method can reduce the manufacturing cost and simplify the manufacturing process.

### CROSS-REFERENCE TO RELATED APPLICATION

This application claims the priority benefit of Taiwan application serial no. 97140504, filed on Oct. 22, 2008. The entirety of the above-mentioned patent application is hereby incorporated by reference herein and made a part of this specification.

### BACKGROUND OF THE INVENTION

1. Field of the Invention

The present invention generally relates to a method of manufacturing a back electrode of a silicon bulk solar cell, which has a low manufacturing cost and a simple manufacturing process.

2. Description of Related Art

A solar cell capable of directly generating electricity from sunshine is a prospective and clean energy. However, the manufacturing cost of the solar cell must be effectively reduced, so that the solar cell can be widely used to become one of the major power sources.

Recently, various techniques about a point-contact electrode on backside of a silicon bulk solar cell used together with a back passivation layer have been usually proposed on the documents. Generally, an aperture is opened on the back passivation layer by using a photolithographic technique, and then a metal thin film is plated thereon, for example, in a paper issued by the University of New South Wales (UNSW) in Australia, Appl. Phys. Lett., Vol. 66, No. 26, pp. 3636-3638 (1995), an aperture is opened on a back SiO₂ passivation layer by using the photolithographic technique, and then a metal thin film is deposited, thereby improving the efficiency.

However, the cost of the above method is excessively high, and a back electric field structure cannot be naturally formed through the above method, but must be manufactured by diffusing. As a result, such method cannot be used for mass production all the time.

In addition, a laser sintering technique has been proposed by Fraunhofer ISE in Germany, in which a partial back electric field may be formed naturally without the photolithographic process, for example, in U.S. Pat. No. 6,982,218 B2, a passivation film and an electrode metal are deposited on a back of a silicon bulk solar cell, and then a point-contact sintering is performed through laser.

However, in this method, in order to maintain the lowest serially-connected resistance required by the back, a thicker metal layer must be plated through an evaporation or sputtering manner, such that the cost is high and the manufacturing speed is slow.

### SUMMARY OF THE INVENTION

Accordingly, the present invention is directed to a method of manufacturing a back electrode of a silicon bulk solar cell, which is suitable for reducing the manufacturing cost and improving the photoelectric conversion efficiency

The present invention is further directed to a method of manufacturing a back electrode of a silicon bulk solar cell, which is suitable for simplifying the manufacturing process.

As embodied and broadly described herein, the present invention provides a method of manufacturing a back electrode of a silicon bulk solar cell, which includes depositing a passivation layer on a back of a silicon substrate, and then coating a first metal paste on the passivation layer. Thereafter, a first sintering is performed at a high temperature, such that the first metal paste penetrates the passivation layer, joints to the silicon substrate, and diffuses into the back of the silicon substrate. Afterward, a second metal paste is coated on the back of the silicon substrate, and then a second sintering is performed at a low temperature to cure the second metal paste without penetrating the passivation layer, so as to finish the back electrode structure.

The present invention further provides a method of manufacturing a back electrode of a silicon bulk solar cell, which includes depositing a passivation layer on a back of a silicon substrate, and then coating a first metal paste on the passivation layer. Afterward, a second metal paste is coated on the back of the silicon substrate, and the second metal paste covers the first metal paste. Thereafter, a sintering step is performed, such that the first metal paste penetrates the passivation layer, joints to the silicon substrate, and diffuses into the back of the silicon substrate, and the second metal paste is cured without penetrating the passivation layer, so as to finish the back electrode structure.

In the present invention, the back electrode of the silicon bulk solar cell can be formed through the simple metal paste coating manners, so as to avoid the vacuum manufacturing processes with higher cost, for example, evaporation or sputtering manner or solve the problem about the excessive slow film coating speed, thereby accelerating the manufacturing speed and reducing the manufacturing cost. In the manufacturing process of the present invention, a point-contact electrode can be manufactured without the photolithographic process, such that a passivation effect of the passivation film is sufficiently utilized, and meanwhile the back electrode structure of the silicon bulk solar cell can be naturally formed, and thus it is simpler than the conventional art. In the method of the present invention, the point-contact electrode can be manufactured simultaneously as the back electric field is formed, thereby improving the manufacturing efficiency of solar cells.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A to 1D are cross-sectional views of a manufacturing flow of a back electrode of a silicon bulk solar cell according to an embodiment of the present invention.

FIGS. 2A to 2C are cross-sectional views of a manufacturing flow of a back electrode of a silicon bulk solar cell according to another embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

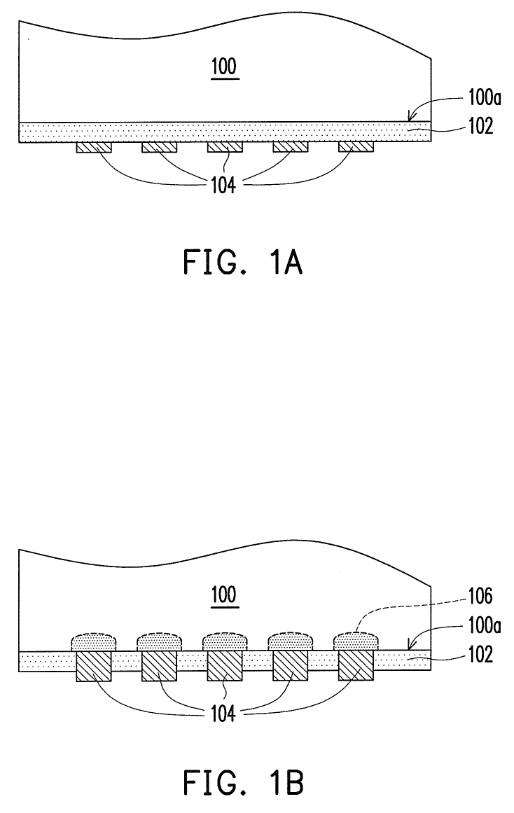

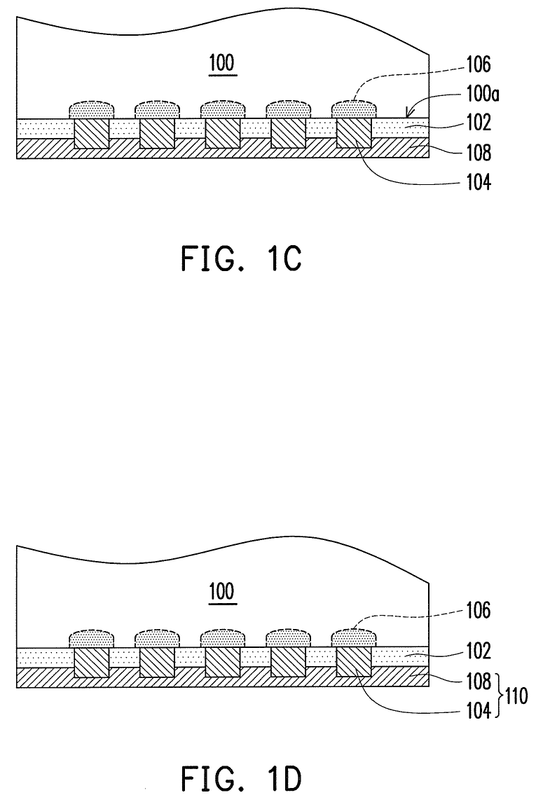

FIGS. 1A to 1D are cross-sectional views of a manufacturing flow of a back electrode of a silicon bulk solar cell according to an embodiment of the present invention.

Referring to FIG. 1A, a passivation layer 102 is deposited on a back 100a of a silicon substrate 100, in which the passivation layer 102 is made of, for example, amorphous silicon, SiO₂, SiN, Al₂O₃, or TiO₂, or the passivation layer 102 may also be a composite layer formed by a plurality of materials selected from a group consisting of amorphous silicon, SiO₂, SiN, Al₂O₃, and TiO₂. The silicon substrate 100 is a substrate in the silicon bulk solar cell, and a front electrode structure may be formed or not formed on a front (not shown) of the silicon substrate 100. Then, a first metal paste 104 is coated on the passivation layer 102, in which the first metal paste 104 is, for example, an aluminum paste, a silver paste, or a silver-aluminum paste. A manner of coating the first metal paste 104 on the passivation layer 102 is, for example, to coat the first metal paste 104 with a spot, linear, or lattice-shaped pattern.

Then, referring to FIG. 1B, a first sintering is performed at a high temperature, such that the first metal paste 104 penetrates the passivation layer 102, joints to the silicon substrate 100, and diffuses into the back 100a of the silicon substrate 100. The high temperature is approximately 600° C.-1000° C. When the first metal paste 104 is the aluminum paste, aluminum ions may diffuse into the silicon substrate 100, such that a p+ diffusion region 106 is formed in the back 100a of the silicon substrate 100.

Next, referring to FIG. 1C, a second metal paste 108 is coated on the back 100a of the silicon substrate 100, in which the second metal paste 108 is, for example, an aluminum paste, a silver paste, or a silver-aluminum paste. It may be known from FIG. 1C that, the second metal paste 108 may contact the first metal paste 104.

Afterward, referring to FIG. 1D, a second sintering is performed at a low temperature to cure the second metal paste 108 without penetrating the passivation layer 102, so as to finish the back electrode structure 110. The low temperature is approximately 100° C.-700° C., and the low temperature of the second sintering is lower than the high temperature of the first sintering.

In order to verify the effect of the embodiment, an experiment is performed as follows.

Firstly, a silicon substrate of a silicon bulk solar cell is manufactured through the existing technique, which includes the following steps.

1. An alkali etching is performed by using KOH, so as to perform a surface structurization on a p-type silicon substrate.

2. In a POCl₃ gas environment, the surface of the p-type silicon substrate diffuses into n-type, so as to form a p-n junction.

3. An edge etching is performed by using plasma.

4. A phosphosilicate glass (PSG) layer formed in the above Step 3 is removed by using a buffered oxide etching (BOE).

5. A film coating of an anti-reflective layer is performed through a plasma-enhanced chemical vapor deposition (PECVD) process.

Next, the steps of the present invention are performed as follows.

1. A SiN layer is deposited on the back of the silicon substrate through the PECVD process to serve as the passivation layer, which has a thickness of approximately 100 nm.

2. A aluminum paste layer with a thickness of approximately 10 μm is coated on the passivation layer through a screen printing process to serve as the first metal paste. The first metal paste has a pattern of square apertures of 150 μm arranged in an array on the whole surface, in which one square aperture is spaced apart from the upper, lower, leftward, and rightward ones for an equal interval of 400 μm.

3. The first sintering with a sintering temperature of approximately 870° C. is performed, such that the first metal paste penetrates the passivation layer, joints to the silicon substrate, and diffuses into the back of the silicon substrate.

4. The aluminum paste is manufactured on the entire surface of the back of the silicon substrate through the screen printing process to serve as the second metal paste.

5. The second sintering with a sintering temperature of approximately 200° C. is performed to cure the second metal paste without penetrating the passivation layer

The measurement results of the solar cell manufactured through the above steps are shown in Table 1.

TABLE 1

| | Jsc | | | |
|---|---|---|---|---|
| | (mA/ | Voc | FF | Efficiency |
| | cm²) | (V) | (%) | (%) |
| Screen printed point-contact electrode | 34.59 | 0.611 | 74.89 | 15.83 |
| Conventional screen printed electrode | 33.63 | 0.601 | 74.97 | 15.15 |

As shown in Table 1, as for the cell using the screen printed point-contact electrode according to the method of the present invention, an open voltage is significantly improved, and the efficiency is higher than that of the conventional screen printed electrode.

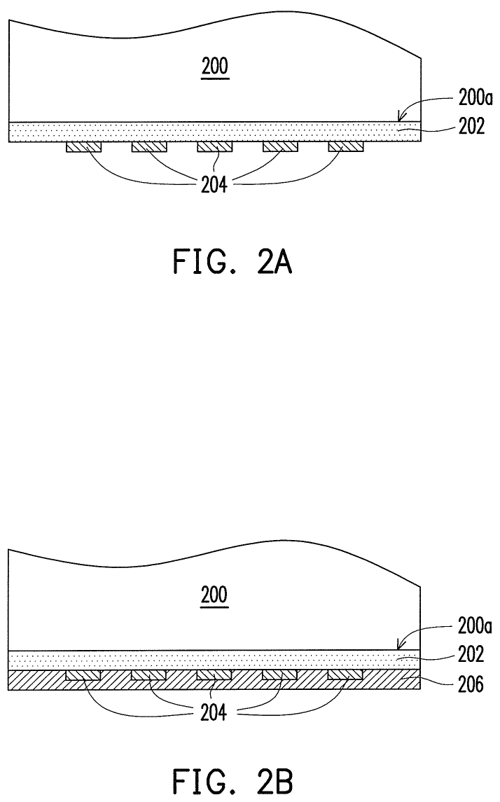

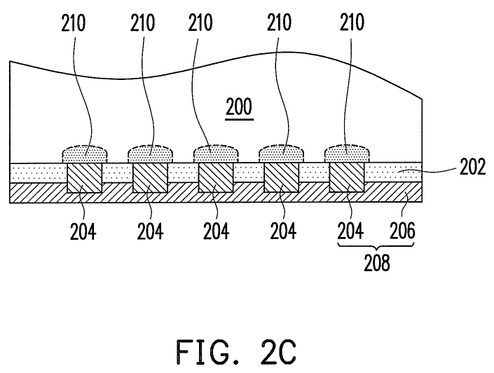

FIGS. 2A to 2C are cross-sectional views of a manufacturing flow of a back electrode of a silicon bulk solar cell according to another embodiment of the present invention.

Referring to FIG. 2A, a passivation layer 202 is deposited on a back 200a of a silicon substrate 200, in which the passivation layer 202 is made of, for example, amorphous silicon, SiO₂, SiN, Al₂O₃, or TiO₂. In other embodiment, the passivation layer 202 may include a composite layer formed by several materials selected from a group consisting of amorphous silicon, SiO₂, SiN, Al₂O₃, and TiO₂. The silicon substrate 200 is a substrate in the silicon bulk solar cell. Then, a first metal paste 204 is coated on the passivation layer 202, in which the first metal paste 204 is, for example, an aluminum paste, a silver paste, or a silver-aluminum paste. A manner of coating the first metal paste 204 on the passivation layer 202 is, for example, to coat the first metal paste 204 with a spot, linear, or lattice-shaped pattern.

Next, referring to FIG. 2B, a second metal paste 206 is coated on the back 200a of the silicon substrate 200, in which the second metal paste 206 is a lead-free and/or glass-free metal paste, for example, an aluminum paste, a silver paste, or a silver-aluminum paste. It may be known from FIG. 2B that, the second metal paste 206 covers the first metal paste 204.

Afterward, referring to FIG. 2C, a sintering step is performed at a temperature of approximately 600° C.-1000° C., such that the first metal paste 204 penetrates the passivation layer 202, joints to the silicon substrate 200, and diffuses into the back 200a of the silicon substrate 200, and meanwhile, the second metal paste 206 is cured without penetrating the passivation layer 202, so as to finish a back electrode structure 208, in which as the first metal paste 204 diffuses into the back 200a of the silicon substrate 200, a p+ diffusion region 210 may be formed.

To sum up, the efficacy of the present invention lies in that, it does not require the vacuum manufacturing processes, for example, evaporation or sputtering processes, thereby enhancing the manufacturing speed and reducing the manufacturing cost. In addition, during the manufacturing process of the present invention, the point-contact electrode can be manufactured without the photolithographic process, such that the back electrode structure of the silicon bulk solar cell can be naturally formed.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of manufacturing a back electrode of a silicon bulk solar cell, comprising:
depositing a passivation layer on a back of a silicon substrate;
coating a first metal paste on the passivation layer;
performing a first sintering at a high temperature, such that the first metal paste penetrates the passivation layer, joints to the silicon substrate, and diffuses into the back of the silicon substrate;
coating a second metal paste on the back of the silicon substrate; and
performing a second sintering at a low temperature to cure the second metal paste without penetrating the passivation layer, so as to finish the back electrode structure.

2. The method of manufacturing a back electrode of a silicon bulk solar cell according to claim 1, wherein the first metal paste is an aluminum paste, a silver paste, or a silver-aluminum paste.

3. The method of manufacturing a back electrode of a silicon bulk solar cell according to claim 1, wherein the high temperature is 600° C.-1000° C.

4. The method of manufacturing a back electrode of a silicon bulk solar cell according to claim 1, wherein the second metal paste is an aluminum paste, a silver paste, or a silver-aluminum paste.

5. The method of manufacturing a back electrode of a silicon bulk solar cell according to claim 1, wherein the low temperature is 100° C.-700° C., and the low temperature is lower than the high temperature.

6. The method of manufacturing a back electrode of a silicon bulk solar cell according to claim 1, wherein a manner of coating the first metal paste on the passivation layer comprises coating the first metal paste with a spot, linear, or lattice-shaped pattern.

7. The method of manufacturing a back electrode of a silicon bulk solar cell according to claim 1, wherein a material of the passivation layer comprises amorphous silicon, SiO₂, SiN, Al₂O₃, or TiO₂.

8. The method of manufacturing a back electrode of a silicon bulk solar cell according to claim 1, wherein the passivation layer comprises a composite layer formed by a plurality of materials selected from a group consisting of amorphous silicon, SiO₂, SiN, Al₂O₃, and TiO₂.

9. A method of manufacturing a back electrode of a silicon bulk solar cell, comprising:
depositing a passivation layer on a back of a silicon substrate;
coating a first metal paste on the passivation layer;
coating a second metal paste on the back of the silicon substrate, wherein the second metal paste covers the first metal paste; and
performing a sintering step, such that the first metal paste penetrates the passivation layer, joints to the silicon substrate, and diffuses into the back of the silicon substrate, and the second metal paste is cured without penetrating the passivation layer, so as to finish the back electrode structure.

10. The method of manufacturing a back electrode of a silicon bulk solar cell according to claim 9, wherein the first metal paste is an aluminum paste, a silver paste, or a silver-aluminum paste.

11. The method of manufacturing a back electrode of a silicon bulk solar cell according to claim 9, wherein a temperature of the sintering step is 600° C.-1000° C.

12. The method of manufacturing a back electrode of a silicon bulk solar cell according to claim 9, wherein the second metal paste is a lead-free metal paste.

13. The method of manufacturing a back electrode of a silicon bulk solar cell according to claim 12, wherein the second metal paste is an aluminum paste, a silver paste, or a silver-aluminum paste.

14. The method of manufacturing a back electrode of a silicon bulk solar cell according to claim 9, wherein the second metal paste is a glass-free metal paste.

15. The method of manufacturing a back electrode of a silicon bulk solar cell according to claim 14, wherein the second metal paste is an aluminum paste, a silver paste, or a silver-aluminum paste.

16. The method of manufacturing a back electrode of a silicon bulk solar cell according to claim 9, wherein a manner of coating the first metal paste on the passivation layer comprises coating the first metal paste with a spot, linear, or lattice-shaped pattern.

17. The method of manufacturing a back electrode of a silicon bulk solar cell according to claim 9, wherein a material of the passivation layer comprises amorphous silicon, SiO₂, SiN, Al₂O₃, or TiO₂.

18. The method of manufacturing a back electrode of a silicon bulk solar cell according to claim 9, wherein the passivation layer comprises a composite layer formed by a plurality of materials selected from a group consisting of amorphous silicon, SiO₂, SiN, Al₂O₃, and TiO₂.
